(19) United States
(12) Patent Application Publication
(10) Pub. No.: US 2006/0272027 A1
(43) Pub. Date: Nov. 30, 2006

(54) Secure access to segment of data storage device and analyzer

(75) Inventor: Gayle Noble, Boulder Creek, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 11/138,042

(22) Filed: May 26, 2005

(51) Int. Cl. H04L 9/32; G06F 12/14; G06F 17/30; G06F 7/04; G06F 11/30; G06K 9/00; H03M 1/68; H04K 1/00; H04L 9/00; H04N 7/16

(52) U.S. Cl. 726/27; 713/193

(57) ABSTRACT

The present invention relates to data security. A data storage device can include an insecure portion and a secure portion of its storage medium. A controller can control access to the storage medium by a computer operating system and communicate a signal to the computer operating system that describes portions of the storage medium, but do not describe the secure portion of the storage medium. Methods for managing access to data stored on a partitioned data storage device, methods for partitioning a data storage device, and methods for monitoring communication between a computer and a data storage device are described.

### CROSS-REFERENCE TO RELATED APPLICATIONS

Not applicable.

### BACKGROUND OF THE INVENTION

1. The Field of the Invention

This application relates generally to hard disk drives. More specifically, this application relates to hard disk drive security.

2. The Relevant Technology

Data storage security can be desirable for many reasons. For example, data storage security may be desirable to insure privacy by preventing unauthorized access to the data stored on the hard disk drive. Data storage security may also be desirable for system integrity purposes to prevent damage to data, for example caused by a computer virus or other damaging or parasitic code. Hard disk drive security may also be desirable to secure a system against spyware, malware, and hackers, as well as for other reasons.

Referring to FIG. 1, an exposed view of a conventional hard disk drive is shown illustrating typical components found therein. The conventional hard disk drive 100 can include a motor (not visible), a spindle 105, platters 110, read/write heads 115, an actuator 120, a housing (partially removed), a frame 125, an interface 135, an air filter 130, and electronics (not visible) including a controller printed circuit board.

The hard disk drive 100 can have one or more platters 110, and each platter 110 usually has a head 115 on each of its sides. Some smaller drives, such as 2.5 inch drives, can have six relatively small platters that are not stacked, but are in a side-by-side arrangement such that the head stack on each platter is independent and can move across its media without effecting where the other heads are on their media. The platters 1 10 are often made from glass or ceramic. A layer of magnetic material is typically deposited/sputtered on the surface of the platters 110. The magnetic material is used to store data and the data structure of the hard disk 100 is typically arranged into concentric circles called sectors.

The platters 110 are typically mounted on a spindle 105 which is turned by a drive motor (not visible) at various speeds depending on the type of hard drive 100. The heads 115 are used to read and write from the platters 110 and can be spring-loaded airfoils. These heads 115 hover above the surface of the platters 110 at a distance typically measured in micro-inches. The hard drive 100 stores information by applying a magnetic field to the moving surface of the platters 110. Hard disk drives provide the data storage on which essentially all modern computers depend.

A hard disk drive interface 135 is the hardware that manages the exchange of data between a computer and the hard drive 100. Most often with computers, the Advanced Technology Attachment interface, also known as the ATA (or IDE) interface is used. Hard drives that use this interface come in a variety of types, such as Ultra ATA, Ultra DMA, or EIDE, depending on the vendor. Other interfaces may also be used such as serial attached SCSI (SAS) and Serial ATA (SATA).

The development and implementation of the IDE interface moved most of the electronics and firmware (low-level software on a chip) from a controller in the computer to a printed circuit board on the hard drive 100 itself. In this process, a buffer/cache memory was added to the electronics to speed-up the process of reading and writing hard disk drive data.

Other types of data storage media are known to one of ordinary skill in the art. For example, there are magnetic, optical data storage media, flash, as well as other types of data storage media. For example, a “Millipede” project by IBM uses thousands of nano-sharp tips to punch indentations representing individual bits into a thin plastic film rather than using traditional magnetic or electronic means to store data. Millipede technology is re-writeable (meaning it can be used over and over again), and may be able to store more than 3 billion bits of data in the space occupied by just one hole in a standard punch card. For operation of the device, the tips are brought into contact with a thin polymer film coating a silicon substrate only a few nanometers thick. Bits are written by heating a resistor built into the cantilever to a temperature of typically 400 degrees Celsius. The hot tip softens the polymer and briefly sinks into it, generating an indentation. For reading, the resistor is operated at lower temperature, typically 300 degrees Celsius, which does not soften the polymer. When the tip drops into an indentation, the resistor is cooled by the resulting better heat transport, and a measurable change in resistance occurs. To over-write data, the tip makes a series of offset pits that overlap so closely their edges fill in the old pits, effectively erasing the unwanted data. More than 100,000 write/over-write cycles have demonstrated the re-write capability of this concept.

To protect information on hard disk drives, and other data storage media, there are several conventional security solutions. For example, firewalls, encryption, and passwords can help control access to specific files or portions of a hard disk drive. Encryption can be implemented by encrypting individual files and by encrypting entire volumes such as a hard drive, hard drive partitions, USB drives, zip disks or tape backups.

One common technique for hard disk drive security is physical isolation. This can be accomplished by keeping confidential data on computers that only authorized individuals can access. Conventional computer systems used by people with varying authorization levels can employ authentication, access control lists, and a privileged operating system to maintain information privacy. This is typically accomplished using software implemented in conjunction with an operating system running on the computer.

Another tool to secure a data storage media is cryptography. Users can encrypt data as it is sent and decrypt it at the intended destination. Secure sockets layer (SSL) encryption protocol, or other protocols, can be used, for example. Information stored on data storage media can also be encrypted so that the information is accessible only by decrypting the data using an appropriate decryption key, password, or code. Cryptographic file systems ask for a decryption key on startup, after which they automatically encrypt data as it's written to a disk and decrypt the data as it is read. If a data storage medium is stolen, the data will be inaccessible. In addition, although many data storage devices are destroyed after they are retired, a significant number are reconditioned and used in the secondary market. Currently, without a cryptographic file system, confidential information can be readily accessed when data storage devices are retired. However, there is still a need to provide better protection for data stored on data storage devices. Thus, what would be advantageous are methods and apparatuses for more secure data storage.

### BRIEF SUMMARY OF THE INVENTION

The present invention relates to data storage security. A data storage device including a storage medium is described. The storage medium can include an insecure portion of the storage medium, a secure portion of the storage medium, a housing enclosing the storage medium, an interface, and a controller coupled to the interface. The controller can include executable instructions stored thereon that when executed by the controller cause the controller to control access to the storage medium by a computer operating system executed on a computer coupled to the interface, and communicate a signal to the computer operating system that describes portions of the storage medium, wherein the signal communicated to the computer operating system does not describe the secure portion of the storage medium.

A method for managing access to data stored on a partitioned data storage device is described. The method can include requesting information from the partitioned data storage device, wherein the partitioned data storage device includes a secure portion and an insecure portion of the partitioned data storage device, and refusing access to the secure portion of the partitioned data storage device in response to an access request received by the data storage device unless an access key is received by the partitioned data storage device and verified.

A method for partitioning a data storage device is described. The method can include partitioning the data storage device into at least two partitions, wherein the partitioned data storage device includes a secure partition and an unsecured partition, and providing a data storage device controller with a access key, wherein the access key must be received by the data storage device controller prior to the data storage device controller providing access to the secure partition.

A method for monitoring communication between a computer and a data storage device is described. The data storage device can include a controller, a secure portion, and an insecure portion. An access key must be received by the controller prior to the data storage device allowing access to the secure portion of the data storage device. The method includes receiving data representing data transmitted between the data storage device and the computer, determining whether the computer requested access to the secure portion of the data storage device, and analyzing the request to determine whether the request was authorized or not.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exploded view of a conventional hard disk drive illustrating typical components found therein;

FIG. 2 illustrates a hard disk drive including a secure storage portion and an insecure storage portion according to an example embodiment of the present invention;

FIG. 3 illustrates a computer system including a hard drive with portions of its storage medium designated as secure and insecure according to an example embodiment of the present invention;

FIG. 4 illustrates a method for managing access to a secure portion of a hard disk drive;

FIG. 5 illustrates a method for setting up a secure portion of a hard disk drive;

FIG. 6 illustrates a method for accessing a secured portion of a hard disk drive;

FIG. 7 illustrates a suitable computer processing environment in which at least certain aspects of many embodiments of the invention may be implemented; and

FIG. 8 illustrates a monitoring device coupled to a computer including a hard disk drive having a secure portion and an insecure portion according to an example embodiment of the present invention.

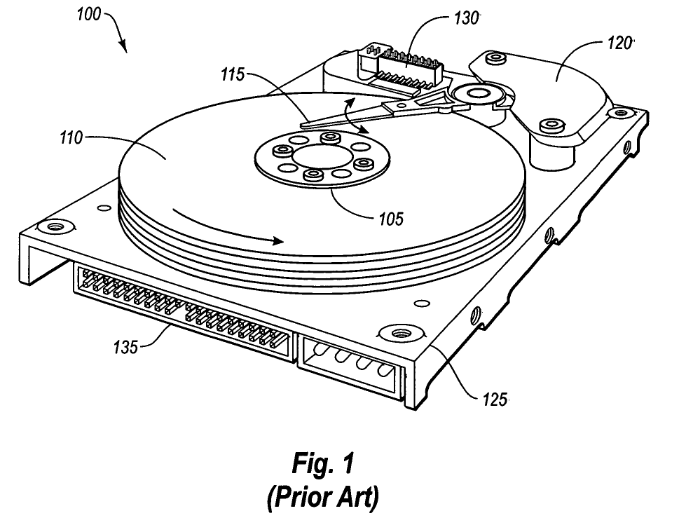

### DETAILED DESCRIPTION OF THE PREFERRED EMBODIMENTS

The present invention relates to secure data storage. The principles of the present invention are described with reference to the attached drawings to illustrate the structure and operation of example embodiments used to implement the present invention. Using the diagrams and description in this manner to present the invention should not be construed as limiting its scope. Additional features and advantages of the invention will in part be obvious from the description, including the claims, or may be learned by the practice of the invention. Detailed descriptions of well-known components and processing techniques are omitted so as not to unnecessarily obscure the invention in detail.

Example embodiments of the present invention can include a special purpose or general-purpose computer, processor, or logic device including various computer hardware, as discussed in greater detail below. Embodiments within the scope of the present invention also include data storage device with computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage, Millipede storage, or other magnetic storage devices, or any other medium which can be used to carry or store desired program code means in the form of computer-executable instructions or data structures and which can be accessed by a general purpose computer, special purpose computer, or other processing device. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Various combinations of the above should also be included within the scope of computer-readable media. Computer-executable instructions comprise, for example, instructions and data which cause a general purpose computer, special purpose computer, or special purpose processing device to perform a certain function or group of functions.

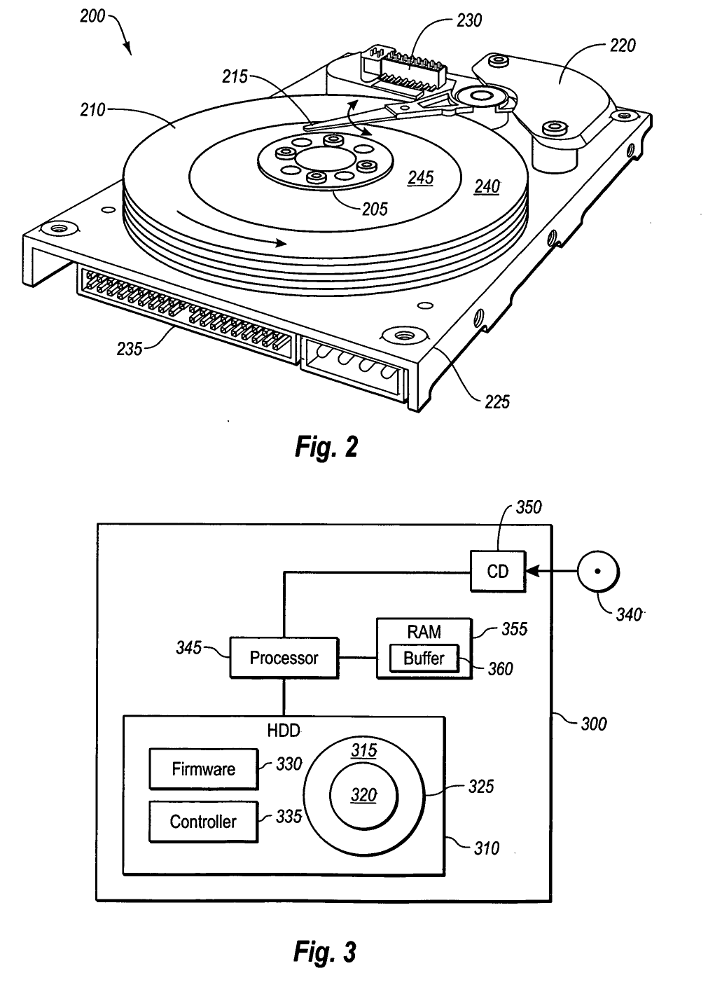

Referring to FIG. 2, a hard disk drive 200 data storage device including a secure storage portion 240 and an insecure storage portion 245 is illustrated according to an example embodiment of the present invention. The hard disk drive 200 can include a motor (not visible), a spindle 205, platters 210, read/write heads 215, an actuator 220, a housing (partially removed), a frame 225, an interface 235, an air filter 230, and electronics (not visible). The electronics on the hard disk drive 200 can include a controller such as a printed circuit board that includes firmware (low-level software on a chip) for controlling communication with a computer processor and access to data stored on the hard disk drive 200.

Data can be stored on the surface of the platters 210 in sectors and tracks. Tracks are concentric circles, and sectors are pie-shaped wedges on a track addressed in any manner. For example, the sectors of the platters 210 can be addressed using cylinder, head and sector numbers. The sectors of the hard disk drive 200 can also be addressed using logical block addressing (LBA). LBA involves assigning each sector of the hard disk drive 200 a unique “sector number”. In essence, the sectors are numbered 0, 1, 2, etc. up to (N−1), where N is the total number of sectors on the disk drive 200 minus bad sectors (sectors that can not be read and written without error), spare sectors (sectors set aside to be used instead of a sector that goes bad) and reserved sectors (sectors used by the drive itself to store defect maps, run time code, and smart data). According to the embodiment illustrated in FIG. 2, a first portion 245 of the platters (or a first set of LBAs, sectors, or tracks) is designated as an insecure portion of the platters, and a second portion 240 of the platters 210 (or a second set of LBAs, sectors, or tracks) is designated a secure portion of the platters 210. For example, where the hard drive 200 is a 40 gigabyte hard drive, the LBAs addressing 30 gigabytes of the hard drive 200 storage space can be designated as insecure 245 and the LBAs addressing 10 gigabytes of the hard drive 200 storage space can be designated as secure 240. Any ratio of secure 240 to insecure portions 245 can be allocated in a hard drive 200.

The insecure portions 245 of the hard disk drive 200 can be accessed by a computer coupled to the interface 235 of the hard disk drive 200 in any manner. Although the insecure portion 245 is referred to as insecure, traditional methods of partitioning and encrypting data on this insecure portion 245 of the hard drive 200 can still be implemented as desirable. Thus, the insecure portion 245 of the hard disk drive 200 can appear to a computer as a hard disk drive having the total volume for storage represented by the insecure disk drive portion 245.

The secure disk drive portion 240 can be “invisible” to a computer coupled to the hard disk drive interface 235. Access to the secure portion 240 of the hard disk drive 200 can be controlled by a controller on the hard disk drive 200. The controller includes firmware or other executable instructions that instruct it to prevent access (e.g., in response to a query by a computer) to the secure portion 240 of the hard disk drive 200 unless the controller first verifies authorization. According to an embodiment of the present invention, the controller will not report information regarding the secure portion 240 of the hard disk drive 200 unless the controller first receives an access key. Thus, a computer (and a user operating the computer) will be prevented from accessing or retrieving information about the secure portion 240 of the hard disk drive 200 unless the computer first provides an access key to the hard disk drive 200 controller. Moreover, there will be no indication to the computer, or a user, that the hard disk drive 200 contains the secure portion 240 until the hard disk drive controller is provided with the access key. Other types of data storage devices, such as but not limited to those described herein, can be configured in a similar manner.

Referring to FIG. 3, an illustration of a computer system 300 including a hard disk drive 310 data storage device with a secure portion 315 and an insecure portion 320 of its storage medium 325 is shown according to an example embodiment of the present invention. The hard disk drive 300 can be any type of data storage device (e.g., hard disk drive 200 in FIG. 2). The hard disk drive 310 can include an insecure portion 320 of its computer readable storage medium 325 (e.g., platters) and a secure portion 315 of its computer readable storage medium 325. The hard disk drive 300 further includes a controller 335 (e.g., a printed circuit board) for controlling access to the computer readable storage medium 325. The controller 335 also provides information about the computer readable storage medium 325, such as total size and available space on the storage medium 325. The hard disk drive 300 can include firmware 330 (e.g., computer executable instructions) that can be part of the controller 335 or can be separate from the controller 335. The firmware 330 provides instructions to the controller 335 including instructions that prevent the controller 335 from describing the secure portion 315 of the storage medium 325 or providing access to the storage medium 325 to a computer processor 345 coupled to the hard disk drive 310 without first receiving an access key. The firmware 330 includes instructions that instruct the controller 335 to allow access to the insecure portion 320 of the storage medium 325 by the processor 345 and allow the controller 335 to provide information describing the insecure portion 320 of the storage medium 325.

An access key can be a code recognized by the hard disk drive controller 335 that indicates to the controller 335 that the access to the secure portion 315 of the hard disk drive 310 is authorized. The access key can be any number, code, value, password, signal, or the like. According to an example embodiment, the access key can also be stored: in the firmware 330 of the hard disk drive 310 by the manufacturer of the hard disk drive 310. In this manner, only the hard disk drive 310 has access to the access key. The access key can also be stored on a removable computer readable medium, such as a compact disk 340 (i.e. a CD-ROM) that is received by an optical drive 350 coupled to the processor 345. The compact disk 340 can store control software that operates independent of the operating system of the computer processor 345. In this manner; the operating system of the computer processor 345 never receives the access key or becomes directly involved with acquiring access to the secure portion 315 of the hard disk drive 300.

All components of the control software contained on the compact disk 340 can be loaded on to temporary memory coupled to the computer processor 345. For example, the control software can include instructions to transmit the access key to the hard disk drive 300 and provide access to the secure portion 315 of the storage medium 325. These instructions can be stored on the computer's 300 random access memory (RAM) 355 such that when the computer 300 is turned off, or the control software is exited, all of the instructions loaded onto the RAM 355 are erased.

The control software loaded onto the RAM 355 can also include instructions for designating a portion of the RAM 355 as a buffer 360 between the secure portion 315 of the storage medium 325 on the hard disk drive 310 and the processor 345. The control software can operate by downloading discrete portions of the secure portion 315 of the storage medium 325 and allowing access to only the portion stored on the buffer 3.60 in the RAM 355 at a time. Thus, none of the secure data is stored on the insecure portion 320 of the storage medium 325. When the computer 300 is turned off or the control software is exited, the data stored in the RAM 355 that was retrieved from the secure portion 315 of the storage medium 325 can be erased. The control software will flush the computer's cache memory before exiting, as computers sometimes write what should be stored in RAM onto a disk cache. The software will also set a key so that if the system crashes, when it re-boots the control software will flush the cache.

After the control software is closed and the compact disk 340 is removed, the processor 345 no longer has access to the access key, and the only place where the access key is stored is in the firmware 330 of the hard disk drive 300. The controller 335 no longer receives the access key and returns to its original operation of reporting information about and providing access to only the insecure portion 320 of the storage medium 325.

The access key and control software can be created by the manufacturer of the hard disk drive 300, for example. This way, the access key can be specific to the hard disk drive 300 or storage medium 325 within the hard disk drive 300. The access key can be a serial number specific to the specific hard disk drive 300. Therefore, each access key will be unique and allow access to the secure portions 315 of only a particular hard disk drive 300. As a result, a single access key cannot be used to access secure portions 315 on multiple hard disk drives 300.

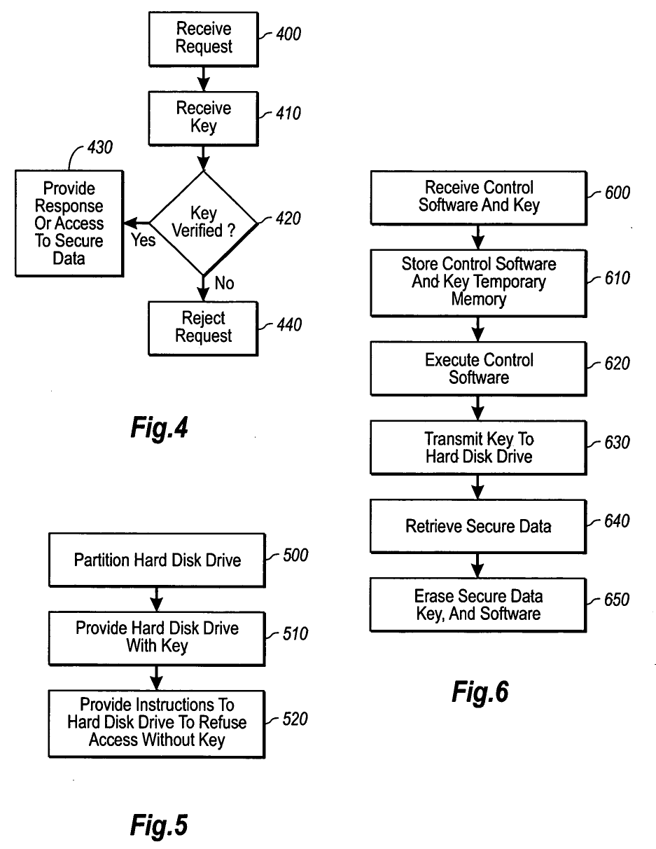

FIG. 4 illustrates a method for managing access to a secure portion of a data storage device. A request for access to the secure portion of the data storage device can be received (400). The request can also ask for information describing the secure portion of the data storage device, or the request can ask to retrieve data from the secure portion of the data storage device or store data to the secure portion of the data storage device. The request can include, for example, LBA addresses specifying locations on the secure portion of the data storage device. The request can be received, for example, by a controller located within, or coupled to, the data storage device containing the secure portion of the data storage device. The controller can control access to both a secure and an insecure portion of the data storage device. There can also be multiple secure portions and multiple insecure portions of the data storage device. There can also be multiple data storage devices where access to secure portions of the data storage devices is controlled by a single or multiple controllers.

An access key can be received (410). The access key can be received by the controller within, or coupled to, the data storage device. The access key can be received before the request, after the request, or at the same time as the request. The access key and the request for access to the secure portion of the data storage device can be received using an interface. The interface can be any interface for communicating with the data storage device. The interface can be Ultra ATA, Ultra DMA, EIDE, USB, Firewire, serial attached SCSI (SAS) and Serial ATA (SATA), for example. The interface can also be a custom interface specifically designed to receive requests for access to the secured portions of the data storage device.

The access key can be verified (420). The access key can be verified by comparing the access key to an access key stored in firmware on the data storage device, for example. The access key can be specific to the particular data storage device, such as a serial number, or can provide access to the secure portions of multiple data storage device. In the instance that the access key is verified, the request is granted and access to the secure portion of the data storage device or information about the secured portion of the data storage device is allowed (430). The access key can be verified in the instance that the access key received matches an access key stored on the firmware of the data storage device. The comparison can be made by the controller. In the instance that the access key is not verified, the request can be rejected (440). The request can be rejected by a response that indicates that the secure portion of the data storage device does not exist. Or that the request is invalid for any number of reasons. In this manner, with out supplying a proper access key, the controller can act as if the secure portion of the data storage device does not exist.

Referring now to FIG. 5, a method for setting up a secure portion of a data storage device is illustrated. A partition can be set up on the data storage device (500). The partition can define a secure portion of the data storage device and an insecure portion of the data storage device. There can also be multiple partitions defining multiple secure portions and multiple insecure portions of a data storage device. Additional partitions can also be set up for other reasons as are well known in the art.

A controller located on the data storage device can be provided with an access key (510). The access key provided to the controller can be a code or value that the controller can compare to an access key received by the controller to verify that access to the secure portion of the data storage device is authorized. The access key can be provided to the controller by firmware or other executable instructions that can be part of the controller or separate and distinct from the controller (or the hard disk drive) but accessible to the controller. The controller can retrieve the access key for verifying that the access key received by the controller with a request is authorized for access to the secure data.

The controller can be provided with executable instructions describing how to respond to requests for access to the secure portion of the data storage device (520). The instructions can be included in the firmware discussed above where the access key is stored. The instructions can instruct the controller to act as if the secure portion of the data storage device does not exist unless the controller receives a correct access key along with the request. Requests received along with a correct access key that is verified by the controller can be referred to as authorized requests and requests received by the controller without a correct access key that cannot be verified can be referred to as unauthorized requests. Authorized requests can be treated as if the secure portion of the data storage device is an integral part of the unsecured portion of the data storage device. For example, the controller can report a total capacity of the data storage device including the capacities of both the secure and insecure portions of the data storage device as a single storage volume. The controller can also provide access to the secure portion of the data storage device as a separate partition, or volume, within the data storage device.

Referring now to FIG. 6, a method for accessing a secure portion of a data storage device is illustrated according to an example embodiment of the present invention. Control software can be received from a removable computer readable medium along with an access key (600). The control software and access key can be stored on a temporary storage medium, such as a RAM coupled to the computer processor (610). The control software, secure data, and key can also be stored in a temporary portion of the insecure portion of the data storage device that is erased when the software is exited. The secure data can also be accessed directly from the secure portion of the data storage device without use of a temporary buffer or memory storage located on the RAM. The control software can be executed or can execute automatically (620) and all files, data and executables of the control software can be located on the temporary memory. The control software can include low level instructions that do not interact with the operating system of the computer.

The access key can be transmitted to the data storage device (630). It should be appreciated that the access key can be retrieved by the control software and transmitted directly to the data storage device controller without the access key being saved in the temporary memory. The access key can be transmitted using the data storage device interface coupled to the computer and received by the data storage device interface coupled to the data storage device. The data storage device controller can verify the access key and provide access to the secure portion of the data storage device.

Data located on the secure portion of the data storage device can be retrieved (640). This data retrieved from or stored on the secure portion of the data storage device can be referred to as secure data, and data retrieved from or stored on the insecure portion of the data storage device can be referred to as insecure data. The secure data retrieved can be stored in a temporary memory. A buffer can be apportioned on a temporary storage medium (e.g., a RAM coupled to the processor). The processor can then access the secure data from the temporary buffer. The processor can be restricted in the manner in which it is allowed to access the data by the control software. For example, the control software can be designed to limit the processor's ability to transfer the data to external media, to access the secure data using other software (e.g., the operating system software being run on the processor), or the control software can allow unrestricted access to the secure software by the processor and other applications being run on the processor. Settings of the control software can be established by the manufacturer or a user.

When the control software program is closed, or the computer is turned off, the secure data stored in the temporary memory is erased along with any temporarily stored data relating to the control software that was temporarily stored in the temporary memory (650). The temporary memory can also be a portion of the insecure portion of the data storage device that is erased when the control software is exited. Additional methods can be implemented to insure that the data stored in the temporary memory is not retrievable. For example, in some instances “deleting” a file may remove a file system entry that points to a file. The file may still exist on the memory at least until it is overwritten. In some instances, the file will also exist even after it gets overwritten. In some instances, even files that have been overwritten can be recovered. It may be a benefit to overwrite the deleted secure data several times. For example, the first overwrite can include all ones, the second overwrite can include all zeroes, and a third overwrite can include alternating pattern of ones and zeros. The file can also be overwritten several times with random data. Other methods for erasing the data stored in the temporary memory known to one of ordinary skill in the art can also be implemented.

Conventional methods of securing data can be used in conjunction with any aspects of the present invention. For example, cryptographic checksums, encryption, and additional user designated passwords can be used to protect the secure data, the access key, the control software, and access to any portions of the system or data storage device. For example, the secure data can be encrypted each time it is stored on, or retrieved from, the data storage device or a temporary memory. The access key stored on the data storage device or the access key transmitted to the data storage device can be encrypted. The controller on the data storage device can decrypt the access key received and/or the access key stored in the firmware of the data storage device prior to verifying the access key received. A cryptographic hash can also be used, which is a high-quality checksum of the original access key. To validate the access key, the controller would recompute the checksum on the entered access key, and see if it matches the stored checksum. One advantage to this is that the control software never stores the actual access key.

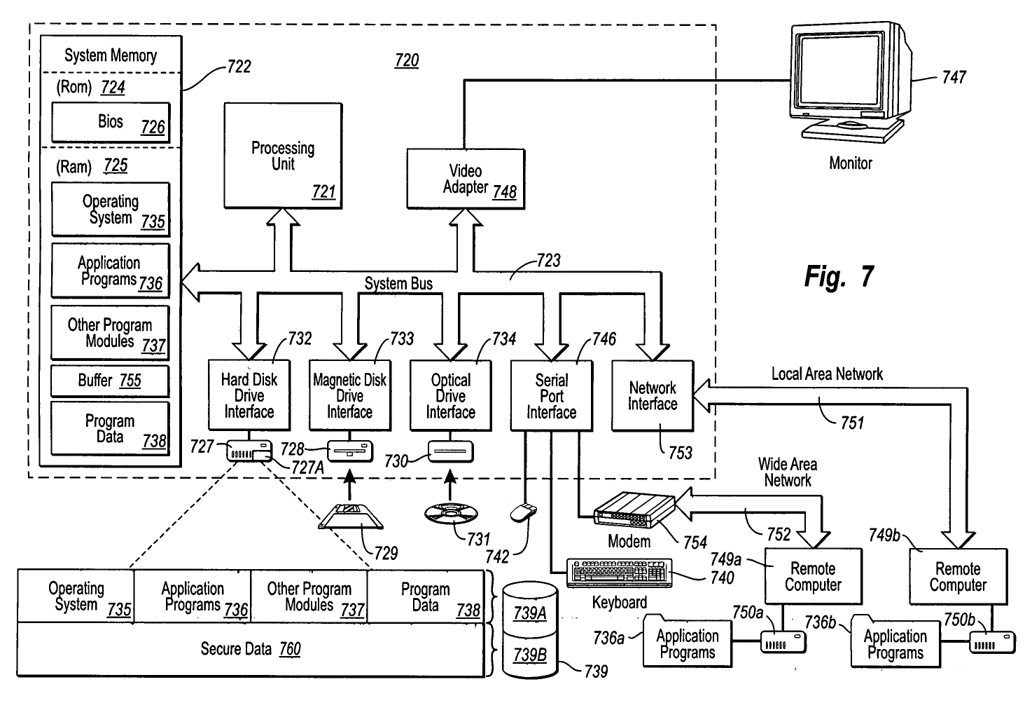

FIG. 7 and the following discussion are intended to provide a brief, general description of a suitable computer processing environment in which at least certain aspects of many embodiments of the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. These acts and steps can be performed on a computer as described, or may be performed at least in part using other logic devices executing instructions implemented as logic (i.e. instructions) loaded onto the logic device.

Those skilled in the art will appreciate that the invention may be practiced in network computing environments with many types of computer system configurations, including personal computers, hand-held devices, multi-processor systems, microprocessor-based or programmable electronic devices, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 7, an example of a system for implementing at least certain aspects of embodiments of the present invention can include a general purpose computing device in the form of a computer 720, including a processing unit 721, a system memory 722, and a system bus 723 that couples various system components including the system memory 722 to the processing unit 721. The system bus 723 may be any of several types of bus structures including a memory bus or memory controller, a peripheral bus, and a local bus using any of a variety of bus architectures. The system memory can include read only memory (ROM) 724 and random access memory (RAM) 725. A basic input/output system (BIOS) 726, containing the basic routines that help transfer information between elements within the computer 720, such as during start-up, may be stored in the ROM 724.

The computer 720 may also include a magnetic hard disk drive 727 data storage device for reading from and writing to a magnetic hard disk 739 data storage device, a magnetic disk drive 728 data storage device for reading from or writing to a removable magnetic disk 729 data storage device, and an optical disk drive 730 data storage device for reading from or writing to removable optical disk 731 data storage device such as a CD ROM or other optical media. The magnetic hard disk drive 727, magnetic disk drive 728, and optical disk drive 730 are connected to the system bus 723 by a hard disk drive interface 732, a magnetic disk drive-interface 733, and an optical drive interface 734, respectively. The drives and their associated computer-readable media provide nonvolatile storage of computer-executable instructions, data structures, program modules and other data for the computer 720. Although the exemplary environment described herein employs a magnetic hard disk 739, a removable magnetic disk 729 and a removable optical disk 731, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 739, magnetic disk 729, optical disk 731, ROM 724 or RAM 725, including an operating system 735, one or more application programs 736, other program modules 737, and program data 738. A user may enter commands and information into the computer 720 through access keyboard 740, pointing device 742, or other input devices (not shown), such as a microphone, joy stick, game pad, satellite dish, scanner, or the like. These and other input devices are often connected to the processing unit 721 through a serial port interface 746 coupled to system bus 723. Alternatively, the input devices may be connected by other interfaces, such as a parallel port, a game port or a, universal serial bus (USB). A monitor 747 or another display device may also be connected to system bus 723 via an interface, such as video adapter 748. In addition to the monitor, personal computers typically include other peripheral output devices (not shown), such as speakers and printers.

The hard disk 739 data storage device can include a secure portion 739A and an insecure portion 739B. The hard disk drive 727 can include a controller 727A for controlling access to the different portions of the hard disk 739. The controller 727A can include firmware, or have access to internal or external firmware, that includes computer-executable instructions for performing the different tasks described herein. The controller can limit access to the secure portion 739A of the hard disk 739 by the processing unit 721 or any other device. The controller can respond to requests as if the secure portion 739A of the hard disk 739 does not exist. The controller can respond in any manner. For example, the controller can respond as if the hard disk 739 is limited to the size of insecure portion 739B and only allow access to the insecure data located on the insecure portion 739B. The general purpose data and software, such as the operating system 735, application programs 736, other program modules 737 and program data 738 can be stored on the insecure portion 739B of the hard disk 739 and readily accessible to the processing unit 721 and other devices.

The controller 727A can include firmware, or have access to firmware, that instructs the controller to validate an access key received by the hard disk drive 727. The controller 727A can validate the access key received and allow access to the secure portion of the hard disk 739 only if the access key is the correct access key. To validate the access key received, a validation key, or other means of validating the access key, is stored on the firmware and is accessible to the controller 727A.

Control software for accessing the secure portion 739B of the hard drive 727 can be stored on removable media. For example, the control software can be stored on the removable magnetic disk 729 and/or the removable optical disk 731. The removable optical disk 731 can include the control software (i.e. executable instructions) that when loaded on the computer 720 provide access to the secure portion 739A of the hard disk 739. The control software can include instructions that instruct the processing unit 721 to only store the control software in a temporary memory. The control software can also include instructions that allow the control software to operate without the operating system 735. For example, the control software can be stored on a temporary buffer 755 located on the RAM 725 of the computer 720. The control software can access the secure portion 739B, of the hard drive 727 via the system buss 721 and secure data 760 stored on the secure portion 739B of the hard disk 739 can be access and retrieved to the temporary buffer 755 located on the RAM 725 of the system memory 722, or other storage medium. The secure data 760 can then be accessed by the processor 721 and the control software can control the access allowed to the secure data 760 by the processing, unit 721. For example, the control software can limit the processor 72 1, or other device, ability to transfer the secure data 760 to another storage device or medium

When the control software is closed, exited, or the computer is turned off, the control software and secure data stored on the RAM 725 (or other storage medium) can be erased in such a way that it is not recoverable. For example, methods of erasing data such as overwriting the data can be implemented. The control software will flush the computer's cache memory before exiting, as computers sometimes write what should be stored in RAM onto a disk cache. The software will also set a key so that if the system crashes, when it re-boots the control software will flush the cache.

The control software can communicate with the hard disk drive controller 727A to validate an access key indicating that the software is authorized to have access to the secure portion 739B of the hard disk 739 and receive information describing the secure portion 739B of the hard disk 739. The access key can be any data that can be validated by the hard disk controller 727A to insure that access to the secure portion 739B of the hard disk 739 is authorized. For example, the access key can be a number, such as a serial number, that is specific to the particular hard disk drive 727. In this manner, a manufacturer of the hard disk drive 727 can designate the access key and provide the control software and the access key to a purchaser on a removable media along with the corresponding hard disk drive 727 so that the purchaser can determine who has access to the secure portion 739B hard disk drive 727. The access key, as well as the data stored on the hard disk 739 can also be protected using conventional methods such as encryption. Authorization to access either portion of the hard disk drive 727 can be authenticated using the access key according to the present invention, as well as using conventional methods such as authentication using user defined password protection.

Secure access in this manner can be advantageous for many reasons. For example, this embodiment can prevent unauthorized access to private information stored on the secure portion 739B of the hard disk 739. In addition, the existence of the secure portion 739B of the hard disk 739 will not be apparent to the operating system 35 or a person without prior knowledge of the secure portion's 739B existence. The secure portion 739B will not be reported to the operating system 35. In addition, damaging executable codes (e.g., viruses and worms) will not be able to recognize that the secure portion 739B of the hard disk drive 727 exists because they are typically executed using the operating system 735 and the operating system 735 will not be able to recognize or have access to the secure portion 760 of the hard disk drive 727 without the access key or the control software. Therefore protection of stored secure data 760 can be enhanced.

The control software and the access key can also be retrieved across a network. The computer 720 may operate in a networked environment using logical connections to one or more remote computers, such as remote computers 749a and 749b. The computer 720 can communicate remotely with other computers to retrieve the access key and/or the control software. The temporary storage of the secure data 760 can also occur remotely rather than in the RAM 725 so that the secure data 760 is never stored within the computer 720 other than when it is stored in the secure portion 739B of the hard disk 727. Essentially any aspect of the present invention may take place over a network or other communication link. Remote computers 749a and 749b may each be another personal computer, a server, a router, a network PC, a peer device or other common network node, and typically include many or all of the elements described above relative to the computer 720, although only memory storage devices 750a and 750b and their associated application programs 736a and 736b have been illustrated in FIG. 7. The logical connections depicted in FIG. 7 include a local area network (LAN) 751 and a wide area network (WAN) 752 that are presented here by way of example and not limitation. Such networking environments are commonplace in office-wide or enterprise-wide computer networks, intranets and the Internet.

When used in a LAN networking environment, the computer 720 is connected to the local network 751 through a network interface or adapter 753. When used in a WAN networking environment, the computer 720 may include a modem 754, a wireless link, or other means for establishing communications over the wide area network 752, such as the Internet. The modem 754, which may be internal or external, is connected to the system bus 723 via the serial port interface 746. In a networked environment, program modules depicted relative to the computer 720, or portions thereof, may be stored in the remote memory storage device. It will be appreciated that the network connections shown are examples: and other means of establishing communications over wide area network 752 may be used.

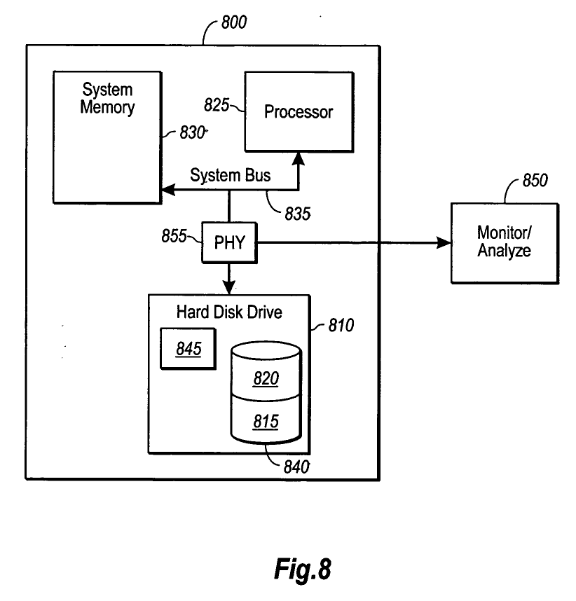

According to another aspect of the present invention, a monitoring device, such as an analyzer, can be implemented to monitor communication between the secure portion of the hard disk and any other device. Referring now to FIG. 8, a monitoring device 850 is coupled to a computer 800 including a hard disk drive 810 having a secure portion 815 and an insecure portion 820 is illustrated according to an example embodiment of the present invention. The computer 800 can include a processor 825, a system memory 830 and the hard disk drive 810, which are coupled together by a system bus 835. The hard disk drive 810 includes a secure portion 815 and an insecure-portion 820 of its storage medium 840. The hard disk drive 810 also includes a controller 845 for controlling access to the different portions of the storage medium 840. The processor can only obtain access to the secure portion 815 of the hard disk drive 810 after authorization to access the secure portion 815 has been verified by the hard disk drive controller 845. Authorization can be accomplished by an access key being received by the controller 845 similar to that described above. The controller 845 can verify the access key and allow access to the secure portion 815 of the hard disk drive storage medium 840 in the instance that the access key received is verified indicating that access is authorized.

The monitoring device 850, such as an analysis processor, can be coupled to the system bus 835 and can monitor access to the data stored on the secure portion 815 of the hard disk drive 810. Access to the secure data can be monitored, for example, by the LBA request transmitted across the system bus 835 to the hard disk drive 810. The monitoring device 850 can also monitor whether the controller 845 allows access to the secure portion 815 of the hard disk drive 810 or not. The monitoring device 850 can also be coupled directly to the computer 800 for communication between the processor 825 and the monitoring device 850 so that the monitoring device can monitor processes conducted on the computer 800. This may be useful to monitor if several requests are being made to access the secure portion 815 of the hard disk drive 810 by a potential hacker or other unauthorized entry. This may also be useful to keep a log of useful information describing any access to the secured portion 815 of the disk drive 810. For example, a log indicating the time that access was allowed, the amount of data that was accessed, and any processes conducted on the data can be stored in the monitoring device 850.

The monitoring device 850 can be a network analyzer or other data processing device. The monitoring device 850 can monitor access to the secure portion 815 of the hard disk drive as well as conduct analysis on a communication link (e.g., the system bus 835) at the same time. The monitoring device 850 can analyze the communication link for any purpose. For example, the monitoring device 850 can analyze the data transmitted in the communication link to identify passwords, errors in data, and errors in data transfer protocols. The monitoring device 850 can also analyze the data to store information related to a potential unauthorized access to the secure portion 815 of the hard disk drive 810. For example, where the unauthorized access included logging on to the computer 800 as a particular user, the monitoring device 850 can keep a log of a password communicated across the system bus 835, other identifying information transmitted across the system bus 835, or processes conducted on the computer 800. The monitoring device 850 can analyze data transmitted across any communication link between the computer 800 and other computers, such as a network link or the like. While the monitoring device 850 is shown coupled to a physical connection 855 to the system bus 835 near the hard disk drive 810 it should be appreciated that the location of the physical connection 855 can be at any location within or external to the computer 800, and multiple physical connections 855 can be implemented to tap into the data transferred in multiple communications links to monitor and/or analyze the data transfer within the communications links.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A data storage device comprising:
a storage medium comprising:
an insecure portion of the storage medium; and
a secure portion of the storage medium;
a housing enclosing the storage medium;
an interface; and
a controller coupled to the interface, wherein the controller comprises executable instructions stored thereon that when executed by the controller cause the controller to perform the following tasks:
control access to the storage medium by a computer operating system executed on a computer coupled to the interface; and
communicate a signal to the computer operating system that describes portions of the storage medium, wherein the signal communicated to the computer operating system does not describe the secure portion of the storage medium.

2. The data storage device of claim 1, wherein the controller includes executable instructions that prevent the controller from communicating a signal to the computer operating system that describes the secure portion of the storage medium without first receiving an access key.

3. The data storage device of claim 1, wherein the signal is a response to a read capacity command received by the controller.

4. The data storage device of claim 2, wherein the controller includes executable instructions that prevent the controller from allowing access to the secure portion of the storage medium by the computer without first receiving the access key.

5. The data storage device of claim 4, wherein the access key comprises at least one of:
a code that is designated by a manufacturer of the data storage device;
a code that is designated by a user of the computer;
a code that is received by the computer from an external storage medium; and
a low level command, wherein the low level command is not detectable by the computer operating system.

6. The data storage device of claim 4, wherein the access key is encrypted and the controller includes executable instructions that decrypt the encrypted access key.

7. The data storage device of claim 4, wherein the signal is communicated to a control program that is run on the computer, wherein the control program is executed in a temporary memory of the computer.

8. The data storage device of claim 7, wherein data retrieved from the secure portion of the storage medium is stored and accessed by the control program from a temporary memory.

9. The data storage device of claim 7, wherein at least-part of the temporary memory is erased when the control program is closed or the computer is turned off.

10. A computer readable medium comprising the access key of claim 2, the computer readable medium further comprising:
a control program comprising:
executable instructions that coordinate access by a computer to secure data stored on the secure portion of the data storage devices wherein the secure access includes retrieving the secure data from the secure portion of the storage medium in a temporary memory coupled to the computer; and
executable instructions that erase the secure data stored in the temporary memory.

11. The computer readable medium of claim 10, wherein the control program is executed in a temporary memory within the computer.

12. An analyzer for monitoring communication between a computer and the data storage device of claim 1, the analyzer comprising:
a physical connection coupled to a communication link for transferring data between the computer and the data storage device; and
an analysis processor comprising:
an interface for receiving data from the physical connection, the data representing data transferred in the communication link; and
executable monitoring instructions stored on the analysis processor that cause the analysis processor to monitor the data when the monitoring instructions are executed.

13. The analyzer of claim 12, wherein the monitoring instructions cause the analysis processor to monitor data communicated between the computer and the secure portion of the data storage device and causes the analysis processor to store data describing communications between the computer and the secure portion of the data storage device.

14. The analyzer of claim 13, wherein the monitoring instructions cause the analysis processor to recognize a request for access to the secure portion of the data storage device by the LBA address of the secure portion of the data storage device requested.

15. The analyzer of claim 12, wherein the executable monitoring instructions cause the analysis processor to monitor the data to identify an unauthorized attempt to access the secure portion.

16. The analyzer of claim 12, further comprising:
executable analysis instructions stored on the analysis processor for analyzing the data.

17. A method for managing access to data stored on a partitioned data storage device comprising:
requesting information from the partitioned data storage device, wherein the partitioned data storage device includes a secure portion and an insecure portion of the partitioned data storage device; and
refusing access to the secure portion of the partitioned data storage device in response to an access request received by the data storage device unless an access key is received by the partitioned data storage device and verified by the data storage device.

18. The method of claim 17, further comprising:
reporting information describing only the insecure portion of the data storage device in response to a read capacity command received by the data storage device, wherein the read capacity command is received from a computer operating system coupled to the data storage device.

19. The method of claim 18, further comprising:
monitoring communication with the data storage device for at least one of unauthorized access to the secure portion of the data storage device and attempts to obtain unauthorized access to the secure portion of the data storage device.

20. The method of claim 17, further comprising:
reporting information describing the secure portion in response to receiving a access key, wherein the access key comprises at least one of:
a code that is designated by a manufacturer of the data storage device;
a code that is designated by a user of the computer;
a code that is received by a computer from an external storage medium; and
a low level command, wherein the low level command is not detectable by a computer operating system.

21. A method for partitioning a data storage device, the method comprising:
partitioning the data storage device into at least two partitions, wherein the partitioned hard drive includes a secure partition and an unsecured partition; and
providing a data storage device controller with a access key, wherein the access key must be received by the data storage device controller prior to the data storage device controller providing access to the secure partition.

22. The method of claim 21, wherein the access key must be received by the data storage device controller prior to the data storage device controller reporting any information describing the secure portion of the data storage device.

23. A method for monitoring communication between a computer and it's a data storage device, wherein the data storage device comprises a controller, a secure portion, and an insecure portion, and wherein an access key must be received by the controller prior to the data storage device allowing access to the secure portion of the data storage device, the method comprising:
receiving data representing data transmitted between the data storage device and the computer;
determining whether the computer requested access to the secure portion of the data storage device; and
analyzing the request to determine whether the request was authorized or not.

24. The method of claim 24, further comprising:
analyzing the data to determine whether access to the secure portion of the data storage device was authorized.
